(19) United States
(12) Patent Application Publication
(10) Pub. No.: US 2024/0129666 A1
(43) Pub. Date: Apr. 18, 2024

(54) SIGNAL PROCESSING DEVICE, SIGNAL PROCESSING METHOD, SIGNAL PROCESSING PROGRAM, TRAINING DEVICE, TRAINING METHOD, AND TRAINING PROGRAM

(71) Applicant: NIPPON TELEGRAPH AND TELEPHONE CORPORATION, Tokyo (JP)

(72) Inventors: Tsubasa OCHIAI, Musashino-shi, Tokyo (JP); Marc DELCROIX, Musashino-shi, Tokyo (JP); Tomohiro NAKATANI, Musashino-shi, Tokyo (JP); Rintaro IKESHITA, Musashino-shi, Tokyo (JP); Keisuke KINOSHITA, Musashino-shi, Tokyo (JP); Shoko ARAKI, Musashino-shi, Tokyo (JP)

(73) Assignee: NIPPON TELEGRAPH AND TELEPHONE CORPORATION, Tokyo (JP)

(21) Appl. No.: 18/273,272

(22) PCT Filed: Jan. 29, 2021
(86) PCT No.: PCT/JP2021/003278

§ 371 Date: Jul. 20, 2023

(51) Int. Cl. H04R 3/00; H04R 1/32

(52) U.S. Cl. CPC H04R 3/005; H04R 1/326; H04R 1/406

(57) ABSTRACT

An estimation apparatus 10 is a signal processing apparatus for processing an acoustic signal and estimates an observation signal of a virtual microphone arranged virtually from an input observation signal of a real microphone using a deep learning model having a neural network (NN) 11.

### TECHNICAL FIELD

The present invention relates to a signal processing apparatus, a signal processing method, a signal processing program, a learning apparatus, a learning method, and a learning program.

### BACKGROUND ART

In various applications such as voice enhancement, sound source separation and sound source direction estimation, array signal processing techniques using a microphone array (a plurality of microphones) are widely used.

Although performance of array signal processing depends basically on the number of microphones, many devices have constraints when actually operated and it is often difficult to increase the number of microphones. Therefore, an improvement in the performance of a microphone array technique when there are a small number of microphones is desired.

On the other hand, there has been studied a method of estimating a signal of a virtual microphone having been virtually-arranged at a position where a microphone is not actually set and virtually increasing the number of observation microphones. For example, there is a method of estimating a phase component of a virtual microphone signal on the basis of a physical model. The physical model is a model which assumes a plane wave assumption, voice sparsity, a microphone array having a sufficiently narrow interval, and the like.

### CITATION LIST

### Non Patent Literature

[NPL 1] Hiroki Katahira, “Nonlinear speech enhancement by virtual increase of channels and maximum SNR beamformer”, [online], [retrieved Jan. 25, 2021], Internet <URL:https://asp-eurasipjournals.springeropen.com/track/pdf/10.1186/s13634-015-0301-3.pdf>

### SUMMARY OF INVENTION

### Technical Problem

While a signal of a virtual microphone is estimated based on a physical model in the conventional study, the physical model is not always satisfied and there is a problem in that estimating the signal (particularly, a phase) of the virtual microphone is difficult.

The present invention has been made in view of the above, and an object thereof is to provide a signal processing apparatus, a signal processing method, a signal processing program, a learning apparatus, a learning method, and a learning program which are capable of estimating a signal of a virtually-arranged microphone without placing an explicit assumption on the signal.

### Solution to Problem

In order to solve the above-mentioned problem and achieve the object, a signal processing apparatus according to the present invention is a signal processing apparatus for processing an acoustic signal, the signal processing apparatus including an estimating unit which uses a deep learning model having a neural network to estimate an observation signal of a virtual microphone arranged virtually from an input observation signal of a real microphone.

In addition, a learning apparatus according to the present invention includes: an input unit which accepts, as learning data, input of an observation signal of a real microphone and an observation signal actually observed at a position of a virtually-arranged virtual microphone being an estimation object; an estimating unit which estimates an observation signal of the virtual microphone from an input observation signal of a real microphone using a deep learning model having a neural network; and an updating unit which updates a parameter of the neural network so that an estimated observation signal of the of the virtual microphone estimated by the estimating unit approaches an observation signal actually observed at the position of the virtual microphone.

### Advantageous Effects of Invention

According to the present invention, a signal of a virtually-arranged microphone can be estimated without placing an explicit assumption on the signal.

### BRIEF DESCRIPTION OF DRAWINGS

FIG. 1 is a diagram schematically showing an example of an estimation apparatus according to a first embodiment.

FIG. 2 is a flowchart showing a processing procedure of estimation processing according to the first embodiment.

FIG. 3 is a diagram schematically showing an example of a learning apparatus according to a second embodiment.

FIG. 4 is a flow chart showing a processing procedure of learning processing according to the second embodiment.

FIG. 5 is a diagram schematically showing an example of a signal processing apparatus according to a third embodiment.

FIG. 6 is a diagram showing a microphone array arrangement of a CHiME-4 corpus.

FIG. 7 is a diagram showing an example of a computer with which an estimation apparatus, a learning apparatus, and a signal processing apparatus are realized through execution of a program.

### DESCRIPTION OF EMBODIMENTS

Hereinafter, embodiments of the present invention will be described in detail with reference to the drawings. Note that the present invention is not limited to the embodiments. Furthermore, in the description of the drawings, same parts are denoted by same reference signs. In the following description, a denotation “\hat{ }A” with respect to A that is a vector, a matrix, or a scalar is intended to be equivalent to “a symbol in which “\hat{ }” is placed directly above “A””.

### First Embodiment

In the first embodiment, an estimation apparatus for estimating a signal of a virtual microphone arranged virtually for array signal processing using a microphone array will be described.

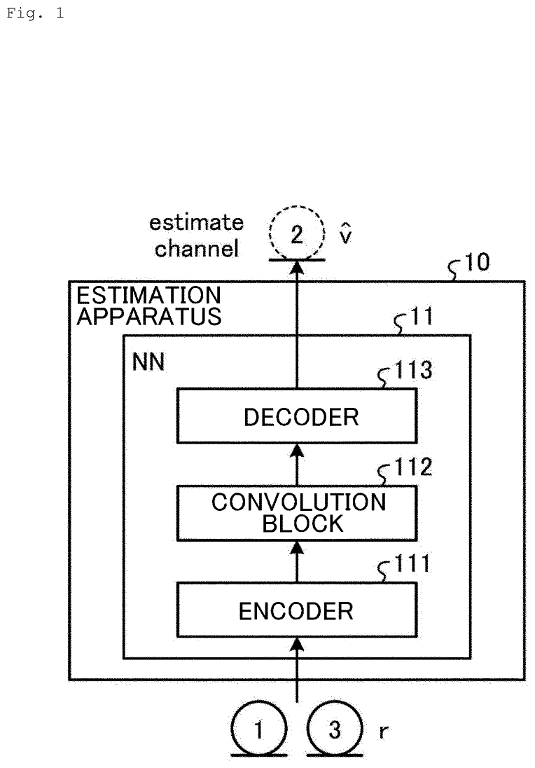

The estimation apparatus according to the first embodiment estimates a signal of a virtually-arranged microphone (virtual microphone) without placing an explicit assumption on the signal. FIG. 1 schematically shows an example of an estimation apparatus according to the first embodiment.

An estimation apparatus 10 (estimating unit) is realized when, for example, a predetermined program is read by a computer or the like that includes a ROM (Read Only Memory), a RAM (Random Access Memory), a CPU (Central Processing Unit), and the like and the CPU executes the predetermined program. In addition, the estimation apparatus 10 has a communication interface for transmitting and receiving various types of information to and from another apparatus connected by a wired connection or via a network or the like.

As shown in FIG. 1, the estimation apparatus 10 according to the first embodiment includes an NN 11. For the sake of brevity, FIG. 1 shows an example in which two channels corresponding to actually-observed real microphones are received and one channel corresponding to a virtual microphone is generated.

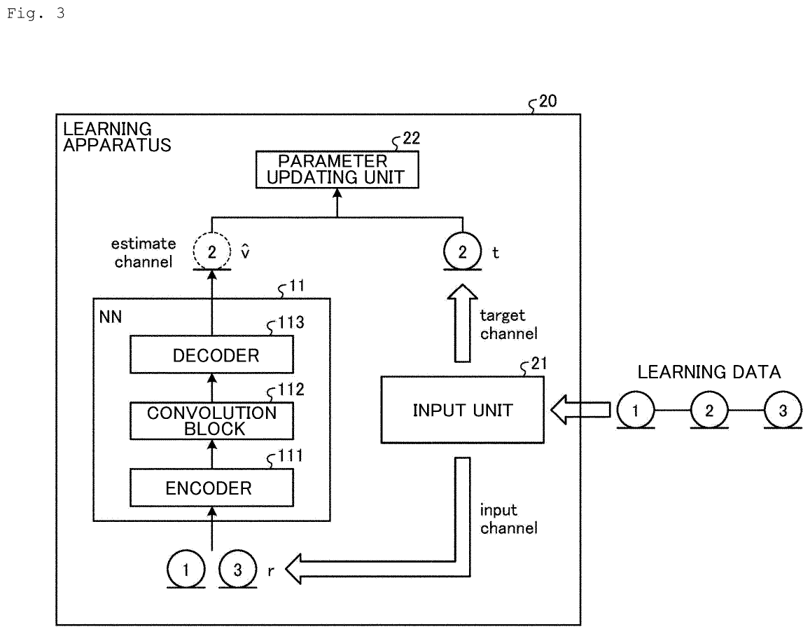

The NN 11 estimates an observation signal (amplitude and a phase component) of a virtually-arranged virtual microphone from an input observation signal observed by real microphones. The real microphones are microphones that are actually installed (in FIG. 1, microphones 1 and 3). Observation signals r of the real microphones are mixed acoustic signals (in FIGS. 1, 1 and 3 circled in solid lines) observed by the real microphones. The virtual microphone is a microphone (in FIG. 1, a microphone 2) virtually-arranged at a position different from the positions of the real microphones. The NN 11 estimates and outputs an observation signal \hat{ }v (in FIG. 1, 2 circled in a dashed line) of the virtual microphone.

The NN 11 is, for example, a time domain/deep learning model having high phase estimation performance. The NN 11 is an NN directly operating in a time domain without being based on a physical assumption and is capable of accurately estimating a time domain signal. Using the NN 11, the estimation apparatus 10 estimates a time domain signal which is an observation signal of a virtual microphone from a time domain signal which is an input observation signal of a real microphone. Hereinafter, in the present first embodiment, NN-based virtual microphone signal estimation (NN-VME: Neural Network-based Virtual Microphone Estimator) which is a method of directly estimating an observation signal of a virtual microphone from a time domain is proposed. The NN 11 need not necessarily be a time domain model and may be realized by a frequency domain model. The NN 11 has an encoder 111, a convolution block 112, and a decoder 113.

The encoder 111 is a neural network for mapping an acoustic signal to a predetermined feature space or, in other words, converting the acoustic signal into a feature vector. The convolution block 112 is a set of layers for performing one-dimensional convolution or the like. The decoder 113 is a neural network for mapping a feature amount on a predetermined feature space to a space of an acoustic signal or, in other words, converting a feature amount vector into an acoustic signal. The NN 11 outputs the observation signal converted by the decoder 113 as an estimation signal \hat{ }v of a virtual microphone.

Configurations of the convolution block, the encoder, and the decoder may be similar to configurations described in Reference 1 (Y. Luo and N. Mesgarani, “Conv-TasNet: Surpassing ideal time-frequency magnitude masking for speech separation”, IEEE/ACM Trans. ASLP, vol. 27, No. 8, pp. 1256-1266, 2019.) In addition, an acoustic signal in the time domain may be obtained by the method described in Reference 1. Furthermore, each feature amount in the following description is to be represented by a vector.

### [Estimation Processing]

Next, a case where the NN 11 estimates one or more virtual microphones at the same time will be described. First, r_{c} denotes a T long-time domain waveform of a c-th real microphone and \hat{ }vₑ, denotes an estimated signal of a c′-th virtual microphone. When a real microphone signal r={r_{c=1}, . . . , r_{c=cr}} is accepted as input, the NN 11 being an NN-VME module estimates a virtual microphone signal \hat{ }v={\hat{ }v_{c}′=1, . . . , \hat{ }v_{c}′=cᵥ} as represented by expression (1).

[Math. 1]

\hat{v}=NN−VME(r) (1)

where Cᵣ represents the number of observation channels (in other words, real microphones), Cᵥ represents the number of virtual estimation channels (in other words, virtual microphones), and NN-VME(·) represents a neural network.

### [Processing Procedure of Estimation Processing]

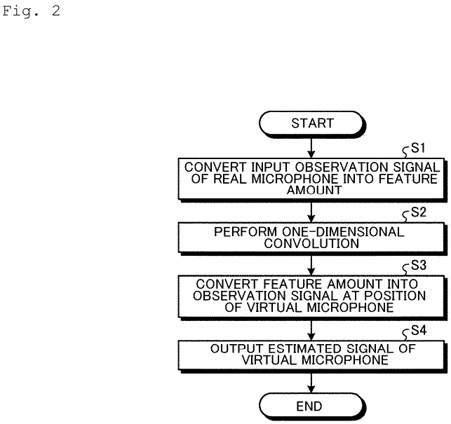

FIG. 2 is a flow chart showing a processing procedure of estimation processing according to the first embodiment. In the estimation apparatus 10, when the observation signal r of the real microphone is input, the input observation signal r of the time domain of the real microphone is converted into a feature amount (step S1). The convolution block 112 performs one-dimensional convolution (step S2).

The decoder 113 converts the feature amount into an observation signal at the position of the virtual microphone (step S3). The NN 11 outputs the observation signal converted by the decoder 113 as an estimation signal \hat{ }v of the virtual microphone (step S4).

### Advantageous Effect of First Embodiment

As described above, the estimation apparatus 10 estimates an observation signal of a virtual microphone directly from an input observation signal observed by a real microphone by using the time domain/deep learning model having high phase estimation performance. In a tenth embodiment, by such a data-driven framework, a signal (amplitude and a phase component) of the virtual microphone can be directly estimated without placing an explicit assumption (for example, a physical model) on the signal. In addition, the estimation apparatus 10 estimates both an amplitude and a phase as the signal of the virtual microphone by using a time domain/deep learning model having high phase estimation performance.

Therefore, according to the present first embodiment, the number of observation microphones can be virtually increased, and even when the number of microphones is small, the performance of the microphone array technique can be improved.

### Second Embodiment

Next, a second embodiment will be described. In the second embodiment, a learning apparatus for training the NN 11 in the estimation apparatus 10 will be explained. In order to cause the NN 11 which is an NN-VNE module to estimate a signal of a virtual microphone, the learning apparatus 20 adopts supervised learning and uses, as learning data, an observation signal of a real microphone at the position of the virtual microphone in addition to an observation signal of the real microphone actually arranged during operation.

FIG. 3 schematically shows an example of the learning apparatus according to the second embodiment. Same components as those in the first embodiment will be denoted by same reference numerals and a description thereof will be omitted. In addition, in FIG. 3, for the sake of brevity, the learning apparatus 20 will be described using an example of executing training of the NN 11 which receives two channels corresponding to real microphones and which generates one channel corresponding to a virtual microphone.

The learning apparatus 20 shown in FIG. 3 is implemented when, for example, a predetermined program is read by a computer or the like including a ROM, a RAM, a CPU, and the like and the CPU executes the predetermined program. In addition, the learning apparatus 20 has a communication interface for transmitting and receiving various types of information to and from another apparatus connected by a wired connection or via a network or the like. The learning apparatus 20 includes the NN 11, an input unit 21, and a parameter updating unit 22.

The input unit 21 accepts, as learning data, input of an observation signal (in FIGS. 3, 1 and 3 circled in solid lines) of real microphones (microphones 1 and 3) that are installed during operation and an observation signal (in FIG. 3, 2 circled in a solid line) actually observed at a position of a virtually-arranged virtual microphone (microphone 2) being an estimation object. The input unit 21 inputs an observation signal r (in FIGS. 3, 1 and 3 circled in solid lines) of the time domain of the real microphone installed during operation to the NN. The input unit 21 inputs an observation signal t (in FIG. 1, 2 circled in a solid line) actually observed at the position of the virtual microphone to the parameter updating unit 22.

Based on the input observation signal r observed by the real microphones (microphones 1 and 3), the NN 11 (estimating unit) estimates an observation signal \hat{ }v (in FIG. 3, 2 circled in a dashed line) of the virtual microphone (microphone 2) arranged virtually.

The parameter updating unit 22 updates the parameter of the NN 11 so that the observation signal \hat{ }v of the virtual microphone estimated by the NN 11 approaches the observation signal t actually observed at the position of the virtual microphone.

### [Learning Processing]

Next, learning processing will be described. The learning apparatus 20 adopts supervised learning in order to cause the NN 11 which is an NN-VME module to estimate a virtual microphone signal. To this end, during learning, an observation signal of a real microphone at the position of a virtual microphone is used as a learning object together with an observation signal of the real microphone.

Therefore, it is assumed that a set of an input signal and a target signal {r, t} is available. Here, t={t_{c}′=1, . . . , t_{c}′=cᵥ}, where to denotes a target signal with respect to a c′-th virtual microphone. FIG. 3 shows a case where a subset of microphones (for example, channels 1 and 3) is assigned as a network input value r while another subset (for example, channel 2) is used as a network target value t.

The NN 11 is trained on the basis of a time domain loss between an estimated signal and a real signal at the position of a virtual microphone. In the parameter updating unit 22, for example, a scale-dependent signal-to-noise ratio (SNR) is adopted as a loss as represented by expression (2).

$$[ Math . 2 ]$$

$$ℒ = {\sum }_{{c}^{′} = 1}^{{C}_{v}} 10 {log}_{10} ( \frac{{‖ {t}_{{c}^{′}} ‖}^{2}}{{‖ {t}_{{c}^{′}} - {\hat{v}}_{{c}^{′}} ‖}^{2}} ) \qquad ( 2 )$$

Here, as described with reference to expression 1, \hat{ }v=NN-VME (r) is satisfied.

### [Processing Procedure of Learning Processing]

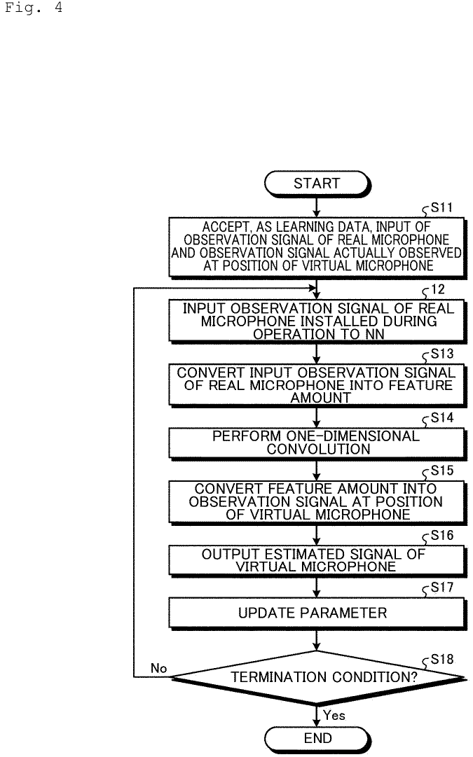

Next, learning processing according to the second embodiment will be described. FIG. 4 is a flow chart showing a processing procedure of learning processing according to the second embodiment.

As shown in FIG. 4, as learning data, input of an observation signal of a real microphone installed during operation and an observation signal actually observed at a position of a virtually-arranged virtual microphone being an estimation object is accepted (step S11). The input unit 21 inputs an observation signal r of a time domain of the real microphone installed during operation to the NN 11 (step S12).

By performing the same processing as steps S1 to S4 shown in FIG. 2, the NN 11 estimates the observation signal \hat{ }v of the virtually-arranged virtual microphone from the input observation signal r observed by the real microphone (steps S13 to S16).

The parameter updating unit 22 updates the parameter of the NN 11 so that the observation signal \hat{ }v of the virtual microphone estimated by the NN 11 approaches the observation signal t actually observed at the position of the virtual microphone (step S17). The parameter updating unit 22 updates the parameter of the NN 11 so that a loss calculated by the expression (2) is optimized.

Subsequently, the parameter updating unit 22 determines whether or not a termination condition is reached (step S18). When the termination condition is reached (step S18: Yes), the learning apparatus 20 terminates the processing, but when the termination condition is not reached (step S18: No), the learning apparatus 20 returns to step S12. Examples of the termination condition include the number of parameter updates with respect to the NN 11 reaching a predetermined number of times, a value of loss used for a parameter update becoming equal to or smaller than a predetermined threshold, and an update amount of a parameter (such as a differential value of a loss function value) becoming equal to or smaller than a predetermined threshold.

### Advantageous Effect of Second Embodiment

As described above, unlike the learning of a voice enhancement method, the learning apparatus 20 according to the second embodiment does not require a pair of a noise-rich signal and a clean signal and requires only observation signals of a plurality of real microphones as learning data. In other words, in the learning apparatus 20, since only the observation signal (mixture acoustic signal) including noise of the multi-channel is required as the learning data, there is no limitation on a shape of devices and mixed acoustic signals of many channels can be used as learning data. In other words, the learning apparatus 20 can use an actual recording having been recorded by a large number of microphones without modification as learning data instead of using a simulated recording.

Therefore, in the learning apparatus 20, learning data can be readily prepared in an inexpensive manner. In addition, using a large amount of learning data enables the learning apparatus 20 to construct a strong NN 11 and the NN 11 enables a precise modeling of actual recording to be performed.

### Third Embodiment

Since the estimation apparatus 10 is capable of generating a virtual microphone signal, the estimation apparatus 10 can be used for various types of array processing. Therefore, in the present third embodiment, a configuration in which the estimation apparatus 10 is combined with a frequency domain beamformer will be described as an example.

### [Signal Processing Apparatus]

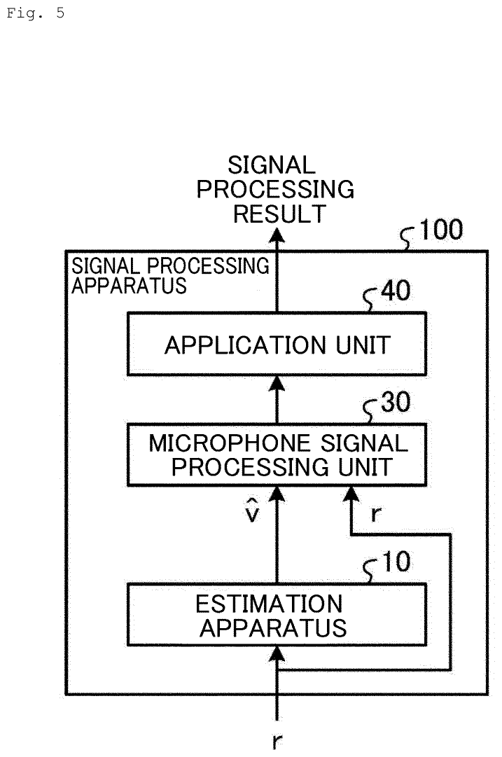

FIG. 5 is a diagram schematically showing an example of a signal processing apparatus according to the third embodiment. A signal processing apparatus 100 shown in FIG. 5 is realized when a predetermined program is read into a computer or the like including a ROM, a RAM, a CPU, and the like and the CPU executes the predetermined program. In addition, the signal processing apparatus 100 has a communication interface for transmitting and receiving various types of information to and from another apparatus connected by a wired connection or via a network or the like. The signal processing apparatus 100 includes the estimation apparatus 10, a microphone signal processing unit 30, and an application unit 40 (signal processing unit).

The microphone signal processing unit 30 generates a voice enhanced signal from which a noise component has been removed on the basis of an observation signal of a real microphone and an observation signal of a virtual microphone estimated by the estimation apparatus 10. Note that the microphone signal processing unit 30 may include sound source separation processing, sound source localization processing, and the like.

The application unit 40 performs another task-dependent processing using the voice enhanced signal. For example, the application unit 40 performs voice recognition processing. A processing order of the signal processing apparatus 100 is simply an example and there may be cases where voice recognition processing is performed after sound source separation processing or where voice enhancement processing and sound source separation processing are performed after sound source localization processing.

### [Processing of Voice Enhancing Unit]

### [Basic Procedure]

First, using the estimation apparatus 10, a virtual microphone signal \hat{ }vϵR^{T×Cv} is estimated from a real microphone signal rϵR^{T×Cr} as described with reference to expression (1) and an extended microphone signal y=[r, \hat{ }v]ϵR^{T×C} (C=Cᵣ+Cᵥ) is obtained. Next, the microphone signal processing unit 30 acquires an enhanced voice signal using a frequency domain beamformer in addition to the extended microphone signal in a frequency domain representation (in other words, a short-time Fourier transform (STFT)). Finally, an enhanced time domain waveform is restored using an inverse STFT.

An enhanced voice signal in an STFT region \hat{ }X_{t,f}ϵC is obtained as \hat{ }X_{t,f}=w^{H}_{f}Y_{t,f}, where Y_{t,f}ϵC represents a vector including a C-channel STFT coefficient of an extended microphone issue in a time frequency bin (t,f), w_{f}ϵC^{C} represents a vector including a beamforming filter coefficient, and ^{H} represents a conjugate transposition.

### [MVDR Formalization]

For example, the microphone signal processing unit 30 uses minimum variance distortionless response (MVDR) (Reference 2: Mehrez Souden, Jacob Benesty, and Sofiene Affes, “On optimal frequency-domain multichannel linear filtering for noise reduction”, IEEE Transactions on Audio, Speech, and Language Processing, vol. 18, No. 2, pp. 260-276, 2009.) to calculate a time invariant filter coefficient w_{f} as represented by expression (3).

$$[ Math . 3 ]$$

$${w}_{f} = \frac{{( {Φ}_{f}^{N} )}^{- 1} {Φ}_{f}^{S}}{Tr ( {( {Φ}_{f}^{N} )}^{- 1} {Φ}_{f}^{S} )} u \qquad ( 3 )$$

where, Φ⁵_{f}ϵC^{C×C} and Φ^{N}_{f}C^{C=C} represent space covariance (SC) matrices of a voice signal and a noise signal, respectively. UϵR^{C} denotes a one-hot vector representing a reference microphone.

In addition, using a time frequency mask, the SC matrix is estimated as represented by expression (4) (Reference 3: Jahn Heymann, Lukas Drude, and Reinhold Haeb-Umbach, “Neural network based spectral mask estimation for acoustic beamforming”, in IEEE International Conference on Acoustics, Speech and Signal Processing (ICASSP), 2016, pp. 196-200.)

$$[ Math . 4 ]$$

$${Φ}_{f}^{ν} = \frac{1}{{\sum }_{t = 1}^{T} {m}_{t , f}^{ν}} {\sum }_{t = 1}^{T} {m}_{t , f}^{ν} {Y}_{t . f} {Y}_{t , f}^{H} \qquad ( 4 )$$

where νϵ{S,N}. m^{S}_{t,f}ϵ[0,1] and m^{N}_{t,f}ϵ[0,1] represent time-frequency masks of voice and noise, respectively.

### [Virtual Microphone Loading]

In an experiment to be described later, it has been found that while the use of a virtual microphone in beamforming is effective in increasing a signal-to-distortion ratio (SDR), automatic speech recognition (ASR) performance is not necessarily improved. This is due to mixing of processing artifacts by virtual microphone estimation.

In order to reduce the influence of the artifacts, a virtual microphone loading term ZϵR^{C} represented by expression 5 is added to the SC matrix Φ^{N}_{f}. In other words, in the microphone signal processing unit 30, a loading term for reducing a weight of a channel of a virtual microphone is added to the spatial covariance matrices of a voice signal and a noise signal.

[Math. 5]

Φ_{f}^{N}←Φ_{f}^{N}+ϵZ (5)

where Z={z_{c,c′}}^{C,C}_{c=1,c′=1} represents a matrix of which elements other than diagonal elements corresponding to a virtual microphone are zero. In other words, z_{cv,cv}=1 is satisfied, cᵥ represents a channel index corresponding to a virtual microphone, and ε represents a loading hyperparameter that controls a contribution of the virtual microphone when the beamformer is formed. For example, a large value being set to ε means that a large noise which does not correlate with other microphones is mixed in the virtual microphone. Therefore, the estimation beamformer can be expected to improve performance of ASR by reducing the weight of the channel of the virtual microphone.

### Advantageous Effect of Third Embodiment

Due to the signal of the virtual microphone estimated by the estimation apparatus 10 having an NN-VME module, an improvement in performances of voice enhancement and signal processing expanded by the NN-VME can also be expected.

### [Experiment]

In order to evaluate NN-VME, the following two evaluations were performed. Namely, an evaluation experiment 1 with respect to virtual microphone estimation performance by NN-VME, and an evaluation experiment 2 with respect to enhancement performance by a beamformer using an estimated virtual microphone. Although a result of estimation of one virtual microphone is reported in the experiment, obviously, the estimation can be expanded to a plurality of virtual microphones.

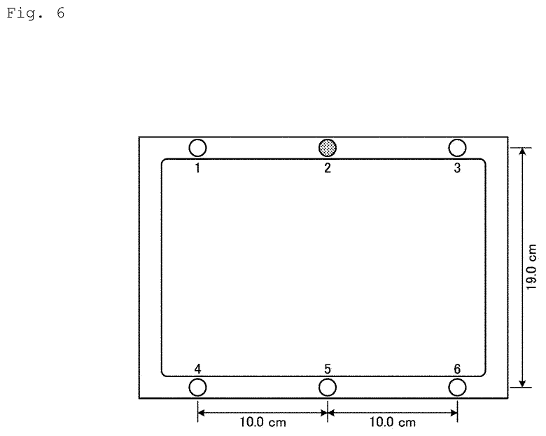

FIG. 6 is a diagram showing a microphone array arrangement of a CHiME-4 corpus. All microphones shown in FIG. 6 face the front with the exception of microphone 2.

### [Experimental Conditions]

NN-VME was evaluated on a CHiME-4 corpus (Reference 4: Jon Barker, Ricard Marxer, Emmanuel Vincent, and Shinji Watanabe, “The third CHiMEspeech separation and recognition challenge: Dataset, task and baselines”, in IEEE Automatic Speech Recognition and Understanding Workshop(ASRU), 2015, pp. 504-511.) As shown in FIG. 6, the CHiME-4 corpus includes voice recorded using a tablet device with a 6-channel rectangular microphone array. The corpus includes not only simulated data but also real recordings in noisy public environments.

A training set is made up of three-hour real voice data uttered by four speakers and 15-hour simulated voice data uttered by 83 speakers. An evaluation set includes 1320 utterances of simulated voice data including actual voice data respectively uttered by four speakers and noise. Among these utterances, an evaluation set made up of 1149 utterances excluding utterances accompanying microphone failures is used.

As an evaluation index, SDR and a word error rate (WER) of BSSEval (Reference 5: Emmanuel Vincent, Remi Gribonval, and Cedric Fevotte, “Performance measurement in blind audio source separation”, IEEE Transactions on Audio, Speech, and Language Processing, vol. 14, No. 4, pp. 1462-1469, 2006.) were used. In order to evaluate virtual microphone estimation performance, SDR between an estimated virtual microphone signal on a channel corresponding to a virtual microphone and an observed real microphone signal was calculated.

In order to evaluate the enhancement performance of the beamformer, a clean reverberation signal in a fourth channel was used as a reference signal. Since access to a clean signal is required, this evaluation is performed only with respect to simulation data.

ASR performance was evaluated using Kaldi's CHiME-4 recipe (Reference 6: Daniel Povey, Arnab Ghoshal, Gilles Boulianne, Lukas Burget, Ondrej Glembek, Nagendra Goel, Mirko Hannemann, PetrMotlicek, Yanmin Qian, Petr Schwarz, Jan Silovsky, GeorgStemmer, and Karel Vesely, “The Kaldi speech recognition toolkit”, in IEEE Automatic Speech Recognition and Understanding Workshop (ASRU), 2011., and Reference 7:[online], [retrieved Jan. 25, 2021], Internet <https://github.com/kaldi-asr/kaldi/tree/master/egs/chime4/s5_6ch>). This is constituted of a deep neural network hidden Markov model hybrid acoustic model (Reference 9: Herve Bourlard and Nelson Morgan, Connectionist speech recognition: A hybrid approach, 1994, and Reference 10: Geoffrey Hinton, Li Deng, Dong Yu, George E Dahl, Abdelrahman Mohamed, Navdeep Jaitly, Andrew Senior, Vincent Vanhoucke, Patrick Nguyen, Tara N Sainath, and Brian Kings bury, “Deep neural networks for acoustic modeling in speech recognition: The shared views of four research groups”, IEEE Signal Processing Magazine, vol. 29, No. 6, pp. 8297, 2012.) having been trained by a lattice-free maximum mutual information criterion (Reference 8: Daniel Povey, Vijayaditya Peddinti, Daniel Galvez, Pegah Ghahremani, Vimal Manohar, Xingyu Na, Yiming Wang, and Sanjeev Khudanpur, “Purely sequence-trained neural networks for ASR based on lattice-free MMI”, in Interspeech, 2016, pp. 2751-2755.). A trigram language model was used for decoding.

### [Experiment Configuration]

A Conv-TasNet-based network architecture was adopted for the network configuration of the NN-VME. According to the description of Reference 1, hyperparameters were set as N=256, L=20, B=256, H=512, P=3, X=8, and R=4.

NN-VME was trained by adopting the Adam algorithm with gradient clipping (Reference 11: Diederik P Kingma and Jimmy Ba, “Adam: A method for stochastic optimization”, in International Conference on Learning Representations (ICLR), 2015.). In this case, an initial learning rate was set to 0.0001. The training was ended after 200 epochs.

For the MVDR beamformer, a trained mask estimation model (refer to Reference 3) provided by a GitHub repository (Reference 12: [online], [retrieved Jan. 25, 2021], Internet <URL:https://github.com/fgnt/nn-gev,>) having been used in Kaldi's CHiME-4 recipe was used. For the STFT calculation, Blackman windows having sets of a length and a shift of 64 ms and 16 ms, respectively, were used. In the ASR experiment, the loading hyperparameter ε represented by expression (5) was set to 0.05.

### [Experimental Result]

### [Evaluation of Virtual Microphone Estimation Performance]

Table 1 shows an SDR [dB] of virtual microphone estimation using an observation signal including noise as a reference signal.

TABLE 1
SDR [dB] for virtual microphone estimator, in which
noisy observed signal is used as reference signal

| mic type | eval ch | ref ch | simu | real |
|---|---|---|---|---|
| RM | 4 | 5 | 12.1 | 8.8 |
| VM | 5 (4, 6) | 5 | 16.6 | 13.8 |
| RM | 5 | 6 | 8.3 | 7.8 |
| VM | 6 (4, 5) | 6 | 12.3 | 11.8 |

In Table 1, RM represents a real microphone and VM represents a virtual microphone estimated by the NN-VME (NN 11). In this case, the reference signal for calculating an SDR is not a clean signal but an observation signal including noise of a channel corresponding to a virtual microphone. Therefore, the virtual microphone estimation performance can be evaluated even with respect to actual recordings.

In Table 1, “eval ch” in a first column represents a channel index of a virtual microphone signal or a real microphone signal used as an estimated signal in an SDR calculation. “ref ch” in a second column represents a channel index of a real microphone signal used as a reference signal. In this case, a display “5 (4, 6)” indicates that a virtual microphone signal in a channel 5 was estimated using real microphone signals in channels 4 and 6. As a reference, a score is compared with an SDR obtained by a nearest real microphone (in other words, a real microphone with a highest SDR). Results thereof are presented in a first row (eval ch4, ref ch5) and a fourth row (eval ch5, ref ch6) in Table 1.

Table 1 shows that a signal estimated by the NN-VME module (for example, “5(4,6)”) has a higher SDR score than an observed signal recorded by a nearby microphone (for example, “4”). These results show that, even with actual recordings, the NN-VME (NN 11) is capable of estimating a virtual microphone signal which is not actually observed by a microphone by utilizing space information estimated from a small number of observed real microphone signals.

Table 1 shows results of interpolation (in other words, virtual microphones positioned between real microphones) (for example, “5 (4, 6)”) and extrapolation in a lateral direction (for example, “6 (4, 5)”). In either case, the NN-VME (NN 11) can predict a virtual microphone signal with a small distortion of a time waveform with an SDR of approximately 12 dB or higher.

### [Evaluation of Enhancement Performance of Beamformer]

Table 2 shows an SDR [dB] of a beamformer using a clean signal as a reference signal. Note that a higher SDR represents better performance and a lower WER [%] represents better performance.

TABLE 2
SDR [dB] (higher is better) and WER [%] (lower is better) for
beamformer, in which clean signal is used as reference signal

| | | |
|---|---|---|
| used ch | SDR | WER |

| Method | real | virtual | (simu) | (real) |
|---|---|---|---|---|
| (1) no process | — | — | 8.6 | 15.8 |
| (2) RM BF | 4, 6 | — | 10.8 | 12.0 |
| (3) RM BF | 4, 5, 6 | — | 14.2 | 9.4 |
| (4) VM BF | 4, 6 | 5 | 13.4 | 11.1 |
| (5) RM BF | 3, 4, 6 | — | 12.7 | 10.0 |
| (6) RM BF | 3, 4, 5, 6 | — | 15.2 | 8.5 |
| (7) VM BF | 3, 4, 6 | 5 | 14.2 | 9.5 |

VM BF in Table 2 represents a beamformer due to an estimated virtual microphone (output of NN 11) and RM BF represents a beamformer due to only a real microphone. In Table 2, a column “real” and a column “virtual” of “used ch (used channel)” represent channel indices corresponding to a real microphone and a virtual microphone used to form the beamformer, respectively. For example, “VM BF” in row (4) is formed by using two real microphone signals (namely, channels 4 and 6) and one virtual microphone signal (namely, a channel 5).

Table 2 shows that VM BF (for example, row (4)) proposed in the first embodiment has a higher SDR score than RM BF (for example, row (2)) formed by a same real microphone signal. In this case, another RM BF (for example, row (3)) corresponds to an upper limit performance of VM BF.

In order to evaluate the performance of the beamformer on a real recording, ASR evaluation was performed in addition to the SDR-based evaluation described above. Table 2 also shows the WER of RM BF and VM BF evaluated in real data.

Even in an actual recording, it was confirmed from the table that the WER of the VM BF (for example, row (4)) proposed in the first embodiment decreased by 0.9% as compared to a corresponding RM BF (for example, row (2)). Similar trends were observed when using a larger number of microphones (rows (5) to (7)).

These results demonstrate that an estimated virtual microphone signal improves enhancement performance when combined with a beamformer.

Furthermore, Table 2 shows the results of VM BF using virtual microphone loading. A WER score of the VM BF without loading is 15.1% under a same condition as row (4) and 13.4% under a same condition as row (7). This indicates that virtual microphone loading is effective in improving ASR performance of the VM BF.

In this manner, it is demonstrated that a signal of a virtual microphone estimated by the NN-VME (NN 11) improves performance of voice enhancement and signal processing extended by the NN-VME.

### [System Configuration of Embodiment]

Each component of the estimation apparatus 10, the learning apparatus 20, and the signal processing apparatus 100 is a functional concept and need not necessarily be physically constructed as illustrated in the drawings. In other words, specific forms of distribution and integration of functions of the estimation apparatus 10, the learning apparatus 20, and the signal processing apparatus 100 are not limited to those illustrated in the drawings, and all of or a part of the functions can be functionally or physically distributed or integrated in arbitrary units according to various types of loads, conditions of use, and the like.

In addition, all of or any part of the processing steps performed in the estimation apparatus 10, the learning apparatus 20, and the signal processing apparatus 100 may be realized by a CPU, a GPU (Graphics Processing Unit), and a program to be analyzed and executed by the CPU and the GPU. Furthermore, each step of processing performed in the estimation apparatus 10, the learning apparatus 20, and the signal processing apparatus 100 may be realized as hardware using a wired logic.

In addition, all of or a part of the processing steps described as being automatically performed among the processing steps described in the embodiments can be manually performed instead. Alternatively, all of or a part of the processing steps described as being manually performed can be performed automatically according to a known method. Furthermore, processing procedures, control procedures, specific names, and information including various types of data and parameters described above and illustrated in the drawings can be appropriately changed unless otherwise specified.

### [Program]

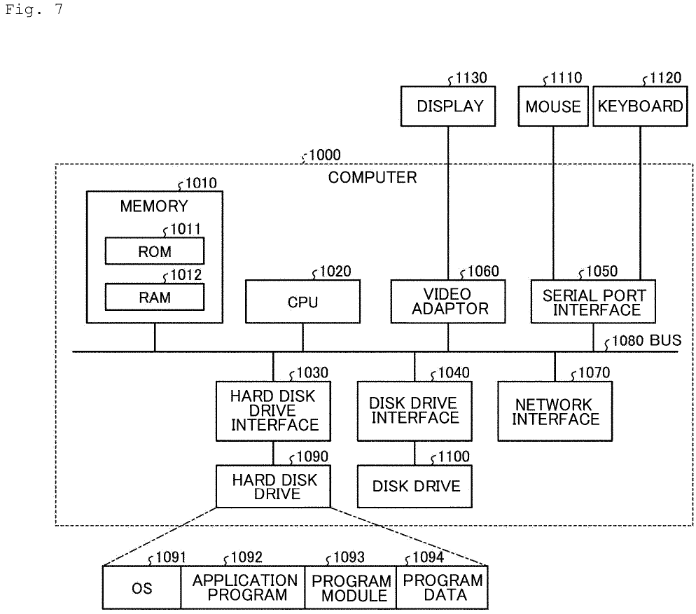

FIG. 7 is a diagram showing an example of a computer with which the estimation apparatus 10, the learning apparatus 20, and the signal processing apparatus 100 are realized through execution of a program. For example, a computer 1000 includes a memory 1010 and a CPU 1020. In addition, the computer 1000 also includes a hard disk drive interface 1030, a disk drive interface 1040, a serial port interface 1050, a video adapter 1060, and a network interface 1070. These units are connected to one another via a bus 1080.

The memory 1010 includes a ROM 1011 and a RAM 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS (Operating System) 1091, an application program 1092, a program module 1093, and program data 1094. In other words, a program that defines each processing step of the estimation apparatus 10, the learning apparatus 20, and the signal processing apparatus 100 is implemented as a program module 1093 in which a code that can be executed by the computer 1000 is described. The program module 1093 is stored in, for example, the hard disk drive 1090. For example, the program module 1093 for executing similar processing steps as the functional components in the estimation apparatus 10, the learning apparatus 20, and the signal processing apparatus 100 is stored in the hard disk drive 1090. Note that the hard disk drive 1090 may be replaced with an SSD (Solid State Drive).

Furthermore, setting data used in the processing of the embodiments described above is stored, for example, in the memory 1010 or the hard disk drive 1090 as the program data 1094. In addition, the CPU 1020 reads the program module 1093 and the program data 1094 stored in the memory 1010 or the hard disk drive 1090 onto the RAM 1012 and executes them as necessary.

The program module 1093 and program data 1094 are not limited to being stored in the hard disk drive 1090 and may also be stored in, for example, a removable storage medium to be read out by the CPU 1020 via the disk drive 1100 or the like. Alternatively, the program module 1093 and the program data 1094 may be stored in another computer connected via a network (a LAN (Local Area Network), a WAN (Wide Area Network, or the like). In addition, the program module 1093 and the program data 1094 may be read by the CPU 1020 from the other computer via the network interface 1070.

Although embodiments to which the invention made by the present inventor is applied have been described above, the present invention is not limited by the description and the drawings that constitute a part of the disclosure of the present invention according to the present embodiments. That is, other embodiments, examples, operational techniques, and the like devised by those skilled in the art or the like on the basis of the present embodiments are all included in the scope of the present invention.

### REFERENCE SIGNS LIST

10 Estimation apparatus
11 Neural network (NN)
111 Encoder
112 Convolution block
113 Decoder
20 Learning apparatus
21 Input unit
22 Parameter updating unit
30 Microphone signal processing unit
40 Application unit
100 Signal processing unit

1. A signal processing apparatus for processing an acoustic signal, comprising:
estimating circuitry which uses a deep learning model having a neural network to estimate an observation signal of a virtual microphone arranged virtually from an input observation signal of a real microphone.

2. The signal processing apparatus according to claim 1, wherein:
the estimating circuitry estimates, using the deep learning model, a time domain signal which is an observation signal of the virtual microphone from a time domain signal which is an input observation signal of the real microphone.

3. The signal processing apparatus according to claim 1, further comprising:
microphone signal processing circuitry which generates a voice enhanced signal from which a noise signal has been removed based on an observation signal of the real microphone and an observation signal of the virtual microphone estimated by the estimating circuitry; and
application circuitry which performs signal processing using the voice enhanced signal, wherein
the microphone signal processing circuitry adds a loading term for reducing a weight of a channel of the virtual microphone to spatial covariance matrices of a voice signal and a noise signal.

4. A signal processing method, comprising the step of:
estimating an observation signal of a virtually-arranged virtual microphone from an input observation signal of a real microphone using a deep learning model having a neural network.

5. A non-transitory computer readable medium storing a signal processing program for causing a computer to function as the signal processing apparatus according to claim 1.

6. A learning apparatus, comprising:
an input circuitry which accepts, as learning data, input of an observation signal of a real microphone and an observation signal actually observed at a position of a virtually-arranged virtual microphone being an estimation object;
an estimating circuitry which estimates an observation signal of the virtual microphone from an input observation signal of a real microphone using a deep learning model having a neural network; and
an updating circuitry which updates a parameter of the neural network so that an estimated observation signal of the of the virtual microphone estimated by the estimating circuitry approaches an observation signal actually observed at the position of the virtual microphone.

7. (canceled)

8. A non-transitory computer readable medium storing a learning program for causing a computer to function as the learning apparatus according to claim 6.

9. A non-transitory computer readable medium storing a signal processing program for causing a computer to perform the method of claim 4.
